(19) United States
(12) Patent Application Publication
(10) Pub. No.: US 2018/0375344 A1
(43) Pub. Date: Dec. 27, 2018

(54) SITUATIONAL BATTERY CHARGING

(71) Applicant: Intel Corporation, Santa Clara, CA (US)

(72) Inventors: Naoki Matsumura, San Jose, CA (US); Majid M. Hashemi, Los Gatos, CA (US); Andrew Keates, Los Gatos, CA (US)

(73) Assignee: Intel Corporation, Santa Clara, CA (US)

(21) Appl. No.: 15/631,607

(22) Filed: Jun. 23, 2017

(51) Int. Cl. H02J 7/00

(52) U.S. Cl. CPC H02J 7/0008; H02J 7/0075; H02J 2007/0096; H02J 7/0077; H02J 7/0018

(57) ABSTRACT

Various embodiments of the invention may pertain to determining the level of charge needed in a rechargeable battery for a battery-powered object, to assure the battery will have sufficient charge to complete an anticipated task, but not so much charge as to shorten the life of the battery unnecessarily. Various anticipated demands on the battery may be considered in determining the level of charge. Various sources of information may be used to determine these anticipated demands. The demands and sources may be manually input and/or automatically retrieved.

### TECHNICAL FIELD OF THE INVENTION

Various embodiments of the invention pertain to charging rechargeable batteries, and in particular to changing the amount of charge delivered based on the anticipated need for power from the battery before its next charging operation.

### BACKGROUND

Due to increasing improvements in battery technology, rechargeable batteries are seen in an increasing number of devices. These rechargeable battery-powered devices may range in size from small devices such as smart phones to large devices such as electric cars. One thing that most of these have in common is that repeatedly charging the battery to its maximum capacity shortens the eventual battery life. Because of this, most manufacturers recommend that batteries only be recharged to a percentage of maximum capacity (such as, for example, 50%). However, depending on the availability of a battery charging system and the power demands to be placed on the battery before its next available charging session, this recommendation may not be optimal. For example, the next anticipated usage may place so little demand on the battery that a 30% charge will be sufficient, thus enhancing eventual battery life. Alternately, the next anticipated usage may place such a great demand on the battery that a near-100% charge may be needed (to avoid depleting the battery completely before the next charging opportunity. Current systems don't have a mechanism to accurately adjust for these changes in anticipated demand on the battery.

### BRIEF DESCRIPTION OF THE DRAWINGS

Some embodiments of the invention may be better understood by referring to the following description and accompanying drawings that are used to illustrate embodiments of the invention. In the drawings:

FIG. 1 shows a computer system for intelligent battery charging, according to an embodiment of the invention.

FIG. 2 shows a high level flow diagram of operations in the charge/discharge phase of a battery, according to an embodiment of the invention.

FIG. 3 shows a flow diagram of operations for determining an estimated charge level for a battery, according to an embodiment of the invention.

FIG. 4 shows a flow diagram of operations for monitoring and recording a discharge phase of a battery, according to an embodiment of an invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented fully or partially in software and/or firmware. This software and/or firmware may take the form of instructions contained in or on a non-transitory computer-readable storage medium. The medium may also be external to a device such as device 100, with the intention that the instructions will eventually be loaded into, and executed by, a device such as device 100. The instructions may be read and executed by the one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

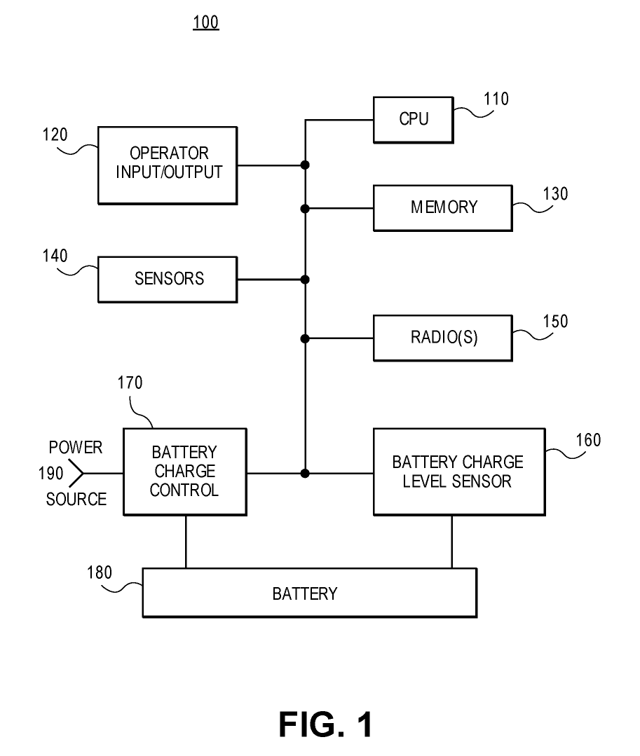

FIG. 1 shows a computer system for intelligent battery charging, according to an embodiment of the invention. System 100 may include CPU 110 and memory 130. Operator input and output 120 may allow a person to provide inputs to, and receive outputs from, the system 100. Such operator I/O devices may include but are not limited to a keyboard, a touchscreen, a display screen, an audio speaker, and various buttons and lights. System 100 may also include various sensors 140, such as but not limited to temperature sensors, an ambient light sensor, a time-of-day clock and/or calendar, etc.

One or more radios 150 may be used to communicate with the outside world to obtain information that may be helpful in predicting the amount of battery charge that will be needed. Finally, a battery charge level sensor 160 may monitor the level of charge in the battery 180, both during a charge phase and during a discharge phase, while battery charge control 170 may control the amount of charge delivered to the battery, as well as the rate at which such charge is delivered. Power source 190 may provide the energy needed to charge the battery during a charge phase.

Much of the following is described in terms of an electric car. But the principals described may be extended to include other types of systems with rechargeable batteries, such as but not limited to a drone or a robot. It should be understood that much of the anticipated demand on the battery during its next operational phase may be an estimate, derived with approximations of things that may not be exactly predictable. Because of this, the final results may include a certain amount of extra charge, above the calculated amount, to provide a safety margin for these unpredictable demands.

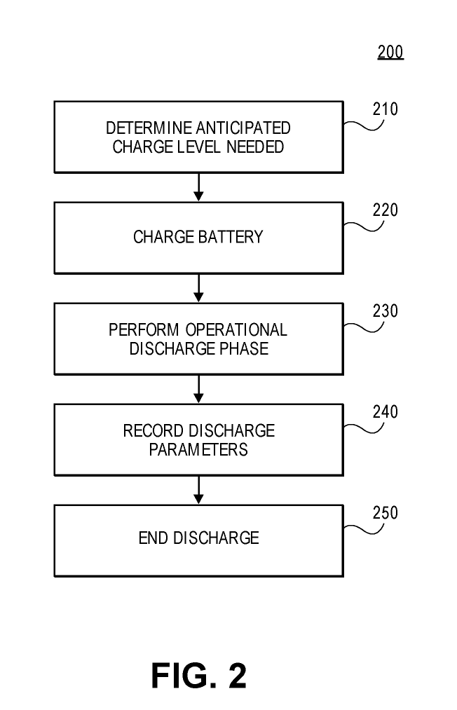

FIG. 2 shows a high level flow diagram of operations in the charge/discharge phase of a battery, according to an embodiment of the invention. In flow diagram 200, at 210 the anticipated charge level that will be needed for the next discharge phase may be determined, and at 220 the battery may be charged up to that level. Operations 210 and 220 may take place simultaneously as the system continues to gather information about the anticipated charge level that will be needed, while the actual charging is taking place. The discharge phase, which may also be referred to as the operational phase because the power stored in the battery may be used for its intended purpose, may be performed at 230. Intermittent periods of no discharge (when the system is temporarily off) may be included in the discharge operation of 230, as long as they occur before the next charge phase begins at 210.

In some embodiments, during the discharge phase of operation 230, any relevant discharge parameters may be monitored and recorded at 240 so they can be used for future charge level calculations. In some embodiments, operation 240 may be (and typically will be) performed within the same time frame as operation 230. Completing the discharge phase at 250 may indicate that the planned discharge operations have been completed. Any unplanned operations may or may not take place after 250, placing extra demands on the battery that were not in the original calculations.

Regarding operation 210, to anticipate the demands that might be placed on the battery during its next operational phase, it may be helpful to divide such demands into several categories. For example, in some embodiments, these can be separated into the following (the examples may be focused on electric cars, but the categories are more widely applicable):

1) environmental factors—these might include anticipated ambient temperature, anticipated battery temperature, altitude, time-of-day (which could affect temperature or anticipated operations), etc.

2) load demand on the battery—in addition to an average steady-date demand (such as driving an electric car on a level road), this could include additional load created by an air conditioning compressor, headlights, radio, etc, as well as a reduced load. Some of these factors might be derived from the environmental factors.

3) duration of the demand on the battery—the time during which the car will be driven may be a factor. This could include additional driving time when longer driving is anticipated such as when traffic is worse than usual or a detour is recommended. This may be different than clock time—for example driving a car to and from work might include one hour of actual driving time with eight hours of off time while the car is sitting in the office parking lot.

4) internal recharging—a car going downhill might benefit from a recharge system within the car that takes advantage of gravitational energy. But going up the hill in the first part of the trip may have the opposite effect if it takes place during the same discharge phase, by placing an additional load on the battery when having to overcome gravity. Similarly, frequent braking during driving may allow the brake recharge system to add to the battery's charge, while frequent acceleration that follows such braking may have the opposite effect.

5) leakage current from the battery—although this might not normally be a factor, extended down times might make it a factor (for example, a car may sit in an airport parking lot for two weeks during an extended business trip, without access to a charging system).

6) history of similar operations—much of the calculation may be based on charge depletion that was observed during similar discharge operations in the past. This history might include multiple ones of the above factors, making individual calculations of those factors less necessary. In some embodiments this history may provide a default starting point for the calculations, which can then be modified for specific details.

7) capacity of the battery—due to the age of the battery and/or its previous long-term usage history, the battery may not be able to provide the amount of capacity that it used to. In some embodiments this may be indicated by internal impedance of the battery.

8) manual override—regardless of any automated calculations, an operator may be able to adjust the charge amounts, either by adjusting individual factors or by adjusting the final charge level.

The information that goes into the aforementioned categories may come from various sources. A partial list of such sources may be:

1) manual operator input—on any of the above categories.

2) a navigation system—that contains the anticipated route to be followed, plus alternate routes to accommodate unforeseen traffic problems.

3) on-line weather forecasts for the anticipated times and areas.

4) topographical maps—of the anticipated areas to determine altitude changes.

5) measured internal impedance of the battery as an indication of the battery's maximum capacity or expected remaining lifetime.

6) weight load—in the case of a car, this might include the number of passengers to be carried.

In some embodiments, the system may repeatedly monitor these sources during the charge phase to assure the final charge amount is based on the most recent data. During the discharge phase indicated at 130 of FIG. 1, the system may provide updated information on whether the battery is following a previously-calculated discharge curve, showing the anticipated charge at various point in the planned discharge operations. This updated information may be based on the device's current status and its progress (location, time, etc.) in the anticipated discharge phase. This updated information may be provided resultant to a deviation from the planned discharge curve, or at predetermined times.

This updated information may be provided in various ways, such as but not limited to:

1) notify the operator—such notification may be handled in various ways, such as but not limited to a text message, an email, a display system, and/or an audio system. A car's internal communication system may be used for such notification.

2) notify other automated systems—such systems may be able to adjust the discharge demands to avoid a premature loss of battery power.

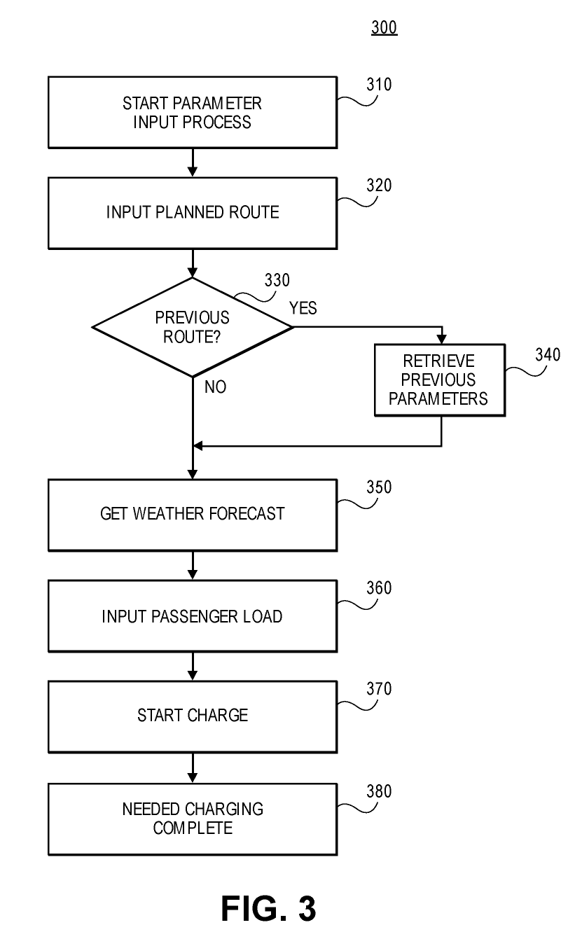

FIG. 3 shows a flow diagram of operations for determining an estimated charge level for a battery, according to an embodiment of the invention. This embodiment is applied to charging the battery of an electric car. In flow diagram 300, the process of entering the various parameters may start at 310. In some embodiments this may be done before the charger is connected to the battery, but in other embodiments the charger may be connected first, since charging is anticipated to take an extended time period.

A planned route for driving the car may be input at 320. In some embodiments this route may be input through the car's existing navigation system, while in other embodiments the charging system may rely on its own route system. If this route has been driven before, as determined at 330, the parameters that were determined from driving this route in the past may be retrieved at 340. If this route has not been driven before, similar information may be collected from the navigation system, topographical maps, etc.

At 350, any data gathered so far may be combined with a weather forecast, which may be retrieved from weather radio or other reliable sources. At 360 the anticipated passenger load may be input, since that may affect the total weight of the car. In most instances, this may be manually input by an operator.

At 370 the charging process may be started. Alternately, the charging process may have been started earlier, before 310 or at any time between 310 and 360. After the battery has reached the intended level of charge, that fact may be indicated at 380. This may be indicated in various ways, such as but not limited to an indicator on the battery charger, a dashboard light in the car, etc.

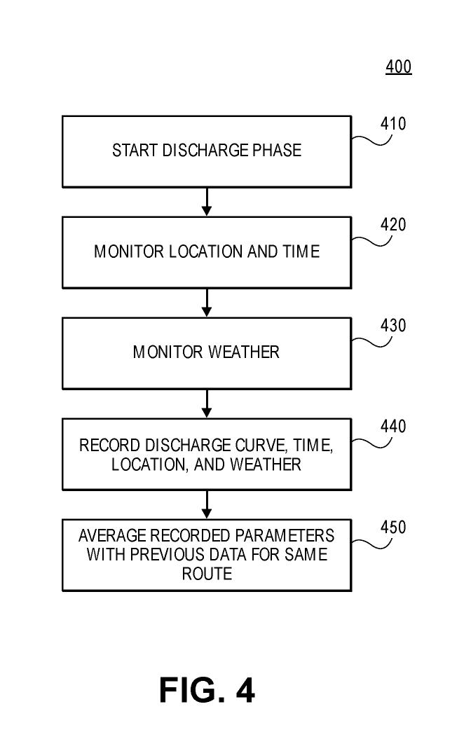

FIG. 4 shows a flow diagram of operations for monitoring and recording a discharge phase of a battery, according to an embodiment of an invention. In flow diagram 400, the discharge phase may start at 410. This may begin when the car is started before driving to the destination. While the car is driving, the system may track the location and time at 420 as the car is driven down the road, and may monitor the weather as well at 430. During this process, the system may monitor the various parameters such as time, location, and weather as the trip progresses, and match these to the charge level in a ‘discharge’ curve’ at 440.

A recording of these and other parameters and the corresponding charge level may be recorded for future reference. Before the next charging phase, this discharge curve may be averaged at 450 with similar recorded parameters from previous instances of the same route get an average of the charge demands for future calculations in the charging phase of FIG. 3.

### EXAMPLES

The following examples pertain to particular embodiments:

Example 1 includes a battery charging device for charging a battery, the device having a processor, a memory, and a charge control module, the device adapted to: receive data related to an anticipated discharge phase for the battery; and determine a charge level for the battery that will provide sufficient energy to complete the discharge phase; wherein the data is to include multiple variable parameters based on a predicted operation of an object powered by the battery.

Example 2 includes the device of example 1, wherein the object is to be selected from a list of objects consisting of: a) an electric-powered automobile, b) a flying drone, and c) a robot.

Example 3 includes the device of example 1, wherein the device is to include the battery.

Example 4 includes the device of example 1, wherein the parameters are to include parameters input by a human operator.

Example 5 includes the device of example 1, wherein the parameters are to include discharge amounts experienced during previous discharge phases of a similar nature.

Example 6 includes the device of example 1, wherein the parameters are to include anticipated ambient temperature during the discharge phase.

Example 7 includes the device of example 1, wherein the parameters are to include a route to be covered.

Example 8 includes the device of example 1, wherein the charge level is to include additional charge to accommodate unforeseen circumstances during the discharge phase.

Example 9 includes an electric powered device having a battery, wherein the device is to: begin a discharge phase with the battery having a charge level pre-determined for a particular task to be performed by the electric powered device; determine anticipated charge levels at multiple stages of the discharge phase; monitor actual charge levels at the multiple stages of the discharge phase; compare the actual charge levels with the anticipated charge levels at the multiple stages; and record the actual charge levels for the multiple stages.

Example 10 includes the electric powered device of example 9, wherein the device is further to average the recorded charge levels with previous charge levels at the same multiple stages.

Example 11 includes a computer-readable non-transitory storage medium that contains instructions, which when executed by one or more processors result in performing operations comprising: receiving data related to an anticipated discharge phase for the battery; and determining a charge level for the battery that will provide sufficient energy to complete the discharge phase; wherein the data is to include multiple variable parameters based on a predicted operation of an object powered by the battery.

Example 12 includes the medium of example 11, wherein the object is to be selected from a list of objects consisting of: a) an electric-powered automobile, b) a flying drone, and c) a robot.

Example 13 includes the medium of example 11, wherein the parameters include anticipated ambient temperature of the battery.

Example 14 includes the medium of example 11, wherein the parameters include parameters input by a human operator.

Example 15 includes the medium of example 11, wherein the parameters include discharge amounts experienced during previous discharge phases of a similar nature.

Example 16 includes the medium of example 11, wherein the parameters include anticipated ambient temperature during the discharge phase.

Example 17 includes the medium of example 11, wherein the parameters include a route to be covered.

Example 18 includes the medium of example 11, wherein the charge level includes additional charge to accommodate unforeseen circumstances during the discharge phase.

Example 19 includes a computer-readable non-transitory storage medium that contains instructions, which when executed by one or more processors result in performing operations comprising: beginning a discharge phase with the battery having a charge level pre-determined for a particular task to be performed by the electric powered device; determining anticipated charge levels at multiple stages of the discharge phase; monitoring actual charge levels at the multiple stages of the discharge phase; comparing the actual charge levels with the anticipated charge levels at the multiple stages; and recording the actual charge levels for the multiple stages.

Example 20 includes the medium of example 19, wherein the operations further include averaging the recorded charge levels with previous charge levels at the same multiple stages.

Example 21 includes a method of estimating a battery charge, the method comprising: receiving data related to an anticipated discharge phase for the battery; and determining a charge level for the battery that will provide sufficient energy to complete the discharge phase; wherein the data is to include multiple variable parameters based on a predicted operation of an object to be powered by the battery.

Example 22 includes the method of example 21, wherein the object is to be selected from a list of objects consisting of: a) an electric-powered automobile, b) a flying drone, and c) a robot.

Example 23 includes the method of example 21, wherein the parameters include anticipated ambient temperature of the battery.

Example 24 includes the method of example 21, wherein the parameters include parameters input by a human operator.

Example 25 includes the method of example 21, wherein the parameters include discharge amounts experienced during previous discharge phases of a similar nature.

Example 26 includes the method of example 21, wherein the parameters include anticipated ambient temperature during the discharge phase.

Example 27 includes the method of example 21, wherein the parameters include a route to be covered.

Example 28 includes the method of example 21, wherein the charge level includes additional charge to accommodate unforeseen circumstances during the discharge phase.

Example 29 includes a method of discharging a battery, the method comprising: beginning a discharge phase with the battery having a charge level pre-determined for a particular task to be performed by the electric powered device; determining anticipated charge levels at multiple stages of the discharge phase; monitoring actual charge levels at the multiple stages of the discharge phase; comparing the actual charge levels with the anticipated charge levels at the multiple stages; and recording the actual charge levels for the multiple stages.

Example 30 includes the method of example 29, wherein the operations further include averaging the recorded charge levels with previous charge levels at the same multiple stages.

Example 31 includes a battery charging device for charging a battery, the device having means to: receive data related to an anticipated discharge phase for the battery; and determine a charge level for the battery that will provide sufficient energy to complete the discharge phase; wherein the data is to include multiple variable parameters based on a predicted operation of an object powered by the battery.

Example 32 includes the device of example 31, wherein the object is to be selected from a list of objects consisting of: a) an electric-powered automobile, b) a flying drone, and c) a robot.

Example 33 includes the device of example 31, wherein the device is to include the battery.

Example 34 includes the device of example 31, further including means to input the parameters by a human operator.

Example 35 includes the device of example 31, wherein the parameters are to include discharge amounts experienced during previous discharge phases of a similar nature.

Example 36 includes the device of example 31, wherein the parameters are to include anticipated ambient temperature during the discharge phase.

Example 37 includes the device of example 31, wherein the parameters are to include a route to be covered.

Example 38 includes the device of example 31, wherein the charge level is to include additional charge to accommodate unforeseen circumstances during the discharge phase.

Example 39 includes an electric powered device having a battery, wherein the device includes means to: begin a discharge phase with the battery having a charge level pre-determined for a particular task to be performed by the electric powered device; determine anticipated charge levels at multiple stages of the discharge phase; monitor actual charge levels at the multiple stages of the discharge phase; compare the actual charge levels with the anticipated charge levels at the multiple stages; and record the actual charge levels for the multiple stages.

Example 40 includes the electric powered device of example 39, wherein the device is further to average the recorded charge levels with previous charge levels at the same multiple stages.

The foregoing description is intended to be illustrative and not limiting. Variations will occur to those of skill in the art. Those variations are intended to be included in the various embodiments of the invention, which are limited only by the scope of the following claims.

What is claimed is:

1. A battery charging device for charging a battery, the device having a processor, a memory, and a charge control module, the device adapted to:
receive data related to an anticipated discharge phase for the battery; and
determine a charge level for the battery that will provide sufficient energy to complete the discharge phase;
wherein the data is to include multiple variable parameters based on a predicted operation of an object powered by the battery.

2. The device of claim 1, wherein the object is to be selected from a list of objects consisting of: a) an electric-powered automobile, b) a flying drone, and c) a robot.

3. The device of claim 1, wherein the device is to include the battery.

4. The device of claim 1, wherein the parameters are to include parameters input by a human operator.

5. The device of claim 1, wherein the parameters are to include discharge amounts experienced during previous discharge phases of a similar nature.

6. The device of claim 1, wherein the parameters are to include anticipated ambient temperature during the discharge phase.

7. The device of claim 1, wherein the parameters are to include a route to be driven.

8. The device of claim 1, wherein the charge level is to include additional charge to accommodate unforeseen circumstances during the discharge phase.

9. An electric powered device having a battery, wherein the device is to:
begin a discharge phase with the battery having a charge level pre-determined for a particular task to be performed by the electric powered device;
determine anticipated charge levels at multiple stages of the discharge phase;
monitor actual charge levels at the multiple stages of the discharge phase;
compare the actual charge levels with the anticipated charge levels at the multiple stages.
record the actual charge levels for the multiple stages.

10. The electric powered device of claim 9, wherein the device is further to average the recorded charge levels with previous charges levels at the same multiple stages.

11. A computer-readable non-transitory storage medium that contains instructions, which when executed by one or more processors result in performing operations comprising:
receiving data related to an anticipated discharge phase for the battery; and
determining a charge level for the battery that will provide sufficient energy to complete the discharge phase;
wherein the data is to include multiple variable parameters based on a predicted operation of an object powered by the battery.

12. The medium of claim 11, wherein the object is an electric-powered automobile.

13. The medium of claim 11, wherein the device includes the battery.

14. The medium of claim 11, wherein the parameters include parameters input by a human operator.

15. The medium of claim 11, wherein the parameters include discharge amounts experienced during previous discharge phases of a similar nature.

16. The medium of claim 11, wherein the parameters include anticipated ambient temperature during the discharge phase.

17. The medium of claim 11, wherein the parameters are to include a route to be driven.

18. The medium of claim 11, wherein the charge level is to include additional charge to accommodate unforeseen circumstances during the discharge phase.
